(19) United States
(12) Patent Application Publication
(10) Pub. No.: US 2006/0201344 A1
(43) Pub. Date: Sep. 14, 2006

(54) Better bale (models 100, 200, 300)

(76) Inventors: Kyle James Taylor, Mesa, WA (US); Hugh D. McEachen, Mesa, WA (US)

Correspondence Address: Kyle J. Taylor, 3800 Astoria Road, Mesa, WA, 99343, US

(21) Appl. No.: 11/078,516

(22) Filed: Mar. 14, 2005

(51) Int. Cl. B30B 5/06

(52) U.S. Cl. 100/88

(57) ABSTRACT

This is the abstract of the technical disclosure for application Ser. No. 11/078,519. This item, which we are trying to patent involves using a hydraulic pressure switch to control inoculant applicators used in baling high moisture alfalfa and other crops. The pressure switch controls a relay that is supplied by a 12-volt source from a tractor. When the moisture content of the product is increased by humidity or dew, the bailer decreases the amount of hydraulic pressure required to make a consistent bale of hay. This added moisture is harmful because it can cause a fire hazard when stacked. The pressure switch responds to the change in hydraulic pressure. This, in turn, activates a relay that switches on the inoculant applicator which allows inoculant to be applied only when moisture content requires it. The application helps to prevent moisture from causing mold, creating heat and causing a fire, or greatly reducing the protein content of the bailed product. A second and/or third pressure switch may also be added to increase the rate of inoculant applied if moisture content requires it.

The Better Bale is an automatic control system for the inoculant applicators used in hay balers. Hay can only be baled safely in large bales (700-2000 lbs) at a moisture content of 15% or below. With the addition of inoculant, hay can be baled at moisture levels up to 20% without the risk of burning the product. Inoculant comes in two forms—granular or liquid.

Our invention automatically turns the applicator system on or off as necessary. This invention will only work with computer controlled balers. In a computer controlled baler, the bale density is controlled by hydraulic pressure regulated by the computer. When the moisture content in the product being baled rises, the hydraulic pressure controlling the bale density drops. This drop in pressure correlates very closely with moisture content of the crop.

Our invention involves the use of an adjustable pressure switch (500-2500 pounds per square inch) plumbed into the bale density hydraulic circuit and a relay to automatically turn the inoculant applicator system on or off as necessary. In addition, a second and/or third pressure switch(s) can be added to increase the rate of inoculant applied to product. The patent we are seeking is use of one, two and/or three switches to control either granular or liquid inoculant applications.

### CROSS REFERENCE TO RELATED APPLICATIONS

The other related systems we are aware of involves the use of a moisture sensor mounted in the bale chamber. This system requires a central processing unit (cpu) and software which increases the cost of the system significantly.

### STATEMENT REGARDING FEDERALLY SPONSORED RESEARCH OR DEVELOPMENT

Not Applicable.

### BACKGROUND OF THE INVENTION

This invention is an agricultural-based application only. Through the invention of this system, we have simplified the technical portion of the system compared to “related applications”, therefore greatly reducing retail cost.

### BRIEF SUMMARY OF THE INVENTION

We wanted to put a system on our baler that allowed us to apply inoculant where needed, however, the cost was prohibitive for our small operation. The process of making quality hay is not exact; varying crop density and field elevation are major obstacles. Our invention has allowed us to increase yields and quality, and to avoid the problem of burnt or discolored bales caused by too excessively high moisture content within the bale.

1. We claim as our invention, the use of a pressure switch plumbed into the pressurized bale density control system on any computer controlled hay baler. This system will automatically control any inoculant applicator system. We claim the use of a second and third pressure switch to increase application rates after initial turn on.
